(19) United States
(12) Patent Application Publication
(10) Pub. No.: US 2025/0154060 A1
(43) Pub. Date: May 15, 2025

(54) USE OF WASTE MATERIALS IN ASPHALT

(71) Applicant: Washington State University, Pullman, WA (US)

(72) Inventors: Haifang Wen, Pullman, WA (US); Maziar Mivehchi, San Bruno, CA (US); Chi-Lin Chiang, Pullman, WA (US)

(21) Appl. No.: 18/948,107

(22) Filed: Nov. 14, 2024

Related U.S. Application Data
(60) Provisional application No. 63/599,451, filed on Nov. 15, 2023.

(51) Int. Cl. C04B 18/02; C04B 24/26; C04B 26/26; C04B 111/00

(52) U.S. Cl. CPC C04B 18/02; C04B 24/2611; C04B 26/26; C04B 2111/0075

(57) ABSTRACT

Methods for asphalt paving disclosed here incorporate waste recycled asphalt shingles (RAS) or polyethylene (PE) plastics, resulting in durable paving, resistant to rutting and cracking. Methods include mixing RAS or PE as an additive to a designed mix containing loose aggregate and a virgin binder such as asphalt or tar and compacting the mix onto a paving substrate.

### CROSS-REFERENCE TO RELATED APPLICATIONS

This application claims priority to U.S. Provisional Application 63/599,451 filed Nov. 15, 2023, incorporated herein by reference.

### TECHNICAL FIELD

The invention relates to asphalt formulations containing waste materials such as asphalt shingles and plastics and paving methods thereof.

### BACKGROUND

Asphalt paving offers the opportunity to recycle waste material which otherwise ends up in landfills. This can also reduce the need to produce virgin component materials with a high cost and environmental footprint, but too much recycled material can also reduce performance of paved surfaces, such as with increased air voids or decreased elasticity, both of which cause premature deterioration.

Recycled asphalt shingle (RAS) is a recycled material with 25% asphalt binder on average. Its inclusion in new asphalt mixes can potentially decrease the use of virgin binder and the construction cost, while also reducing RAS disposal and preserving environment. Nonetheless, the high level of oxidized binder in RAS presents several challenges. The use of RAS is often limited to 5% as it has been found to adversely affect the cracking performance of the mix. To address these challenges, the current practice involves using a softer virgin binder and/or rejuvenator to counteract its stiffness and aging. On the other hand, achieving adequate compaction density during asphalt mix construction is crucial for optimal pavement performance. Agencies and contractors continuously seek effective methods to achieve optimal compaction.

Asphalt binder is the most expensive material in hot mix asphalt, which usually contributes to about 4 to 6 percent in the asphalt mix. To reduce the cost of mix designs, contractors can incorporate recycled asphalt shingles (RAS) in new mixes, as RAS material contains approximately 19 to 30 percent asphalt binder. RAS material can be post-consumer asphalt shingles (PCAS) or manufacturing waste asphalt shingles (MWAS). On average, the continuous binder performance grade (PG) of PCAS and MWAS is reported to be around 170 and 130, respectively.

Designing asphalt mixes with different RAS ratios has been reported for more than a decade, though popularity of this approach has recently declined. The RAS binder significantly oxidizes, leading to higher stiffness and increased cracking susceptibility in the asphalt mix. Previous studies also reported the use of a softer virgin binder and recycling agents in the mixes designed with high amounts of RAP and RAS. Asphalt mixes designed with 5% RAS have been reported to be substantially less durable, with a 70% decrease in the number of cycles to failure. In an analysis of 69 mixes that were designed by contractors for paving jobs, cracking performance of mixes with high RAP and RAS amounts was significantly worse than virgin mixes, despite being designed with softer virgin binder and/or recycling agents. Additionally, the use of a softer binder often leads to a reduction of polymer percentage in a polymer-modified asphalt mix. Research continues to look for solutions to offset the adverse effects of RAS on the cracking performance of asphalt mixes with only limited success. The issue at stake is that while RAS binder is active in compaction and thus reduces the need for virgin binder, it is not effectively active at service temperature, compromising the cracking performance. Efforts to render RAS binder active at service temperature prove to be difficult, if not impossible.

One of the pillars of current mix design and quality verification during construction is that parameters (e.g., volumetrics) at laboratory compaction temperature are used as indicators of field performance of asphalt mixture at service temperatures. While this may be possible for conventional asphalt binders, the use of unconventional asphalt, such as RAS asphalt, greatly challenges that practice. This is because RAS binder is almost as active as conventional binder at mixing and compaction temperature and thus reduces the dosage of virgin binder, but minimally active at the service temperature, as mentioned above. On the other side, it is known that adequate compaction is essential to the performance of asphalt pavement. It has been reported that when field density increases by 1%, pavement service life is extended by 10% conservatively. Therefore, agencies and contractors often seek methods to improve compaction of asphalt mixes during construction. Many factors can affect the compaction of an asphalt mix, including field conditions, compaction method, aggregate gradations and properties, and asphalt binder amount and properties. Among these factors, the binder content greatly affects the compactibility of an asphalt mix. A “dry” mix with low design asphalt content can be difficult to compact, while a “wet” mix with high design asphalt content can compact easily. In either case, additional asphalt binder beyond the designed optimum asphalt content can facilitate compaction, though excessive asphalt content may lead to a tender mix.

Along with RAS, each year, millions of tons of waste plastics are produced by human activities and most of them end up in landfills or enter ecosystems. Using waste plastics in asphalt construction presents a great opportunity for utilizing large quantities of waste plastics, due to the amount of asphalt mixtures produced each year. As one of the most common plastic wastes in the world, polyethylene (PE) has been recycled and utilized to improve the performance of asphalt pavement. However, the influence of using PE of different sizes or forms to modify the asphalt mixture is yet to be thoroughly understood. Previous studies on the use of waste plastics as part of mix design have shown mixed results. As noted above, adequate compaction is key to asphalt pavement performance and agencies/contractors strive to improve compactibility of asphalt mixtures.

Plastic is a synthetic polymer that has been broadly used for different reasons, such as plastic bags, water bottles, construction pipes, plastic toys, and more. Through 2021, there were approximately 8.3 billion tons of plastic waste around the world, with only 12% incinerated. Integrating waste plastic into asphalt pavement presents a promising approach to address the environmental concerns and potentially reduces the pavement costs by decreasing the need of virgin materials. However, the feasibility of this approach mainly relies on the relative performance of these waste plastic mixtures compared to the conventional asphalt mixes.

The incorporation of waste plastic into asphalt mixtures can be achieved using three different processes: namely wet process, dry process, and modified dry process. In the wet process, waste plastics are added to the asphalt binder at high temperatures, altering the properties of the binder and enhancing its engineering performance. However, there are concerns regarding the performance and stability of the binder modified with waste plastics. On the other hand, the dry process eliminates the need for specialized equipment (like a high shear mixer) since the plastic particles are blended with the aggregates prior to adding the asphalt binder to the mix. Following this method, a thin layer of melted polymer forms between the aggregate and the binder, thereby improving the aggregate properties, such as adhesion. The modified dry process starts with blending and enveloping the aggregates with asphalt binder, followed by the addition and thorough integration of plastic particles with the asphalt mixture. This approach aims to minimize the changes in properties and shape of the plastic during mixing. However, even if the plastic has a low melting point, an effective mixing of the waste plastic following the dry and modified dry processes still requires a high temperature.

In terms of volumetrics, previous studies have examined the impact of incorporating waste plastics (such as Polyethylene Terephthalate (PET) and Polystyrene (PS)), into asphalt mixtures using the dry method. These studies have shown that the introduction of waste plastic using the dry method tends to increase the air voids (Vₐ) and voids of mineral aggregate (VMA). An incomplete coverage of the aggregates by the melted plastic was observed, caused by a lack of homogencity in the coating process, resulting in an increase in Vₐ content. In a study substituting up to 10% of the asphalt binder with PET using the dry method resulted in an increased in voids filled with asphalt (VFA) from 72% to 78%. However, another recent study employed a modified dry process with low-density polyethylene (LDPE) and found that the melted LDPE acted as asphalt binder, increased the VMA, and ultimately enhanced the durability of the mixture. It also reported an increase in the voids VFA parameter when the LDPE was introduced using either of the dry and modified dry processes.

The impact of waste plastic on the performance of asphalt mixtures has also been evaluated in various studies. Some studies have found that employing the dry and modified dry processes has enhanced the rutting resistance and moisture damage resistance of the asphalt mixture. This improvement is attributed to the increased stiffness and adhesion between plastic-coated aggregate and binder. However, another study showed that Polystyrene (PS) increased the susceptibility of the mix to rutting and moisture damage due to the lack of elasticity in that type of plastic. The incorporation of plastic into asphalt mixtures using a modified dry process typically results in a lower tensile strength ratio (TSR) compared to that of conventional asphalt mixtures. While the dry process has been shown to result in an improved TSR compared to the modified dry process, poor cracking resistance is still the main challenge of incorporating plastic into asphalt mixture, as the overall mix stiffness is increased following this inclusion. Besides the plastic type, its size, form (e.g., pellets, flakes), dosage, and production condition are among the factors that affect the cracking performance of the plastic modified asphalt mix.

On the other hand, the performance of the asphalt mix is also greatly affected by its field density level. A higher field density has been reported to enhance the pavement service life. Therefore, contractors often tend to adopt methodologies to improve the durability of their mixes through enhanced field compaction. While increasing the asphalt binder is considered a viable approach to facilitate field compaction, it may result in a tender mix.

### SUMMARY

Presented here are methods for recycling waste materials while enhancing asphalt paving and reducing use of virgin materials.

In an example embodiment, recycled asphalt shingles (RAS) are mixed with a loose asphalt mix (either before or after virgin asphalt binder is added) without reducing the design content of virgin binder in loose asphalt mix, forming a RAS-asphalt mix which is compacted on a prepared subsurface. In particular, embodiments provide a method for facilitating the compaction of asphalt mixture.

In another embodiment, polyethylene (PE) is mixed with loose asphalt mix (either before or after virgin binder is added) without reducing the design content of virgin binder in loose asphalt mix to form a PE-asphalt mix. In particular, embodiments provide a method for facilitating the compaction of asphalt mixture.

Accordingly, the present invention harnesses new understanding of asphalt paving and compaction with waste materials and provides an opportunity to reduce costs and benefit resource conservation.

One aspect of the disclosure provides a method of asphalt paving, comprising obtaining a designed mix comprising loose aggregate and a virgin binder; adding recycled asphalt shingles (RAS) to the designed mix as an additive to form a RAS mix, wherein RAS is added in an amount sufficient to facilitate compaction; and compacting the RAS mix on a paving substrate at a compaction temperature.

In some embodiments, the virgin binder is selected from asphalt or tar. In some embodiments, after the compacting step, an air void content of a compacted RAS mix is decreased as compared to a compacted designed mix without RAS. In some embodiments, the RAS mix contains 3-7 wt % virgin binder. In some embodiments, the RAS mix further comprises recycled asphalt pavement (RAP). In some embodiments, the RAS mix contains 0.1-10 wt % of the RAS. In some embodiments, the adding step comprises mixing at a temperature of 100-200° C. for 5 seconds to 1 hour. In some embodiments, the compaction temperature is 100-200° C.

Another aspect of the disclosure provides a method of asphalt paving comprising obtaining a designed mix comprising loose aggregate and a virgin binder; adding polyethylene (PE) to the designed mix as an additive to form a PE mix, wherein PE is added in an amount sufficient to facilitate compaction; and compacting the PE mix on a paving substrate.

In some embodiments, the PE is one or more of powdered, shredded, and pelletized PE with maximum dimension of 0.1-50 mm. In some embodiments, the virgin binder is selected from asphalt or tar. In some embodiments, after the compacting step, an air void content of a compacted PE mix is decreased as compared to a compacted designed mix without PE. In some embodiments, the PE mix contains 3-7 wt % virgin binder. In some embodiments, the PE mix comprises further comprises recycled asphalt pavement (RAP). In some embodiments, the PE mix contains 0.1-10 wt % of the PE. In some embodiments, the adding step comprises mixing at a temperature of 100-200° C. for 5 seconds to 1 hour. In some embodiments, the compaction temperature is 100-200° C.

Other features and advantages of the present invention will be set forth in the description of invention that follows, and in part will be apparent from the description or may be learned by practice of the invention. The invention will be realized and attained by the compositions and methods particularly pointed out in the written description and claims hereof.

### BRIEF DESCRIPTION OF THE FIGURES

FIG. 1(A) shows gradation of RAS1 stockpile and RASAID1 Mixes.

FIG. 1(B) shows gradation of RAS2 stockpile and RASAID2 Mixes.

FIG. 2 shows cracking test (CT) index values on load-displacement curve obtained from indirect tension/IDEAL-CT test method (RASAID). Note: PPP=percentage of the peak load in the post-peak area.

FIG. 3(A) shows change in the air void and VMA values with increasing the RASAID ratio for RAS1 Mixes.

FIG. 3(B) shows change in the air void and VMA values with increasing the RASAID ratio for RAS2 Mixes.

FIG. 4(A) shows rutting test results for RAS1 mixes.

FIG. 4(B) shows rutting test results for RAS2 mixes.

FIG. 5(A) shows IDT test results for RAS1 mixes.

FIG. 5(B) shows IDT test results for RAS2 mixes.

FIG. 6A-E shows cracking test results for RASAID1 mixes. FIG. 6(A) shows fracture energy (FE); FIG. 6(B) shows fracture work density (FWD); FIG. 6(C) shows IDT strength; FIG. 6(D) shows CT-index; and FIG. 6(E) shows flexibility index (FI).

FIG. 7A-E shows cracking test results for RASAID2 mixes. FIG. 7(A) shows FE; FIG. 7(B) shows FWD; FIG. 7(C) shows IDT strength; FIG. 7(D) shows CT-index; and FIG. 7(E) shows FI.

FIG. 8 shows gradation of Control with nominal maximum aggregate size (NMAS) ½ in (PlasticAid evaluation).

FIG. 9A-C shows waste PE additives studied: PEM (FIG. 9(A)), PEF (FIG. 9(B)), and PEP (FIG. 9(C)).

FIG. 10 shows load-displacement curve and parameters for CT-index calculation (PlasticAid).

FIG. 11A-C shows volumetric properties of Control with different waste PE and content, for Vₐ (FIG. 11(A)), VMA (FIG. 11(B)), and VFA (FIG. 11(C)).

FIG. 12(A) shows rutting tests results for Control and Control modified with different plastic sizes.

FIG. 12(B) shows final rut depth after 20,000 cycles.

FIG. 13A-D shows cracking test results for Control with different plastic sizes and content, including load-displacement curve (FIG. 13(A)), IDT strength (FIG. 13(B)), CT-index (FIG. 13(C)), and FI (FIG. 13(D)).

### DETAILED DESCRIPTION

In the description herein, a word appearing in the singular encompasses its plural counterpart, and a word appearing in the plural encompasses its singular counterpart, unless implicitly or explicitly understood or stated otherwise. Furthermore, it is understood that for any given component or embodiment, any of the possible candidates or alternatives listed for that component may generally be used individually or in combination with one another, unless implicitly or explicitly understood or stated otherwise. Moreover, the figures are not necessarily drawn to scale, wherein some of the elements may be drawn merely for clarity. Also, reference numerals may be repeated among the various figures to show corresponding or analogous elements. Additionally, any list of such candidates or alternatives is merely illustrative, not limiting, unless implicitly or explicitly understood or stated otherwise. In addition, unless otherwise indicated, numbers expressing quantities of ingredients, constituents, reaction conditions and so forth used in the specification and claims are to be understood as being modified by the term “about.”

Accordingly, unless indicated to the contrary, the numerical parameters set forth in the specification and attached claims are approximations that may vary depending upon the desired properties sought to be obtained by the subject matter presented herein. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the subject matter presented herein are approximations, the numerical values set forth in the specific examples are reported as precisely as possible. Any numerical values, however, inherently contain certain errors necessarily resulting from the standard deviation found in their respective testing measurements.

Various embodiments of asphalt methods and compositions are described herein. In the following description, specific details of systems, components, and operations are included to provide a thorough understanding of certain embodiments of the disclosed technology. A person skilled in the relevant art will also understand that the technology may have additional embodiments. The technology may also be practiced without several of the details of the embodiments described below.

### Specific Description

This disclosure presents new approaches for incorporating waste materials into asphalt. One embodiment—RASAID—uses RAS as a compaction additive in asphalt mixes. This capitalizes on the fact that RAS binder is active at production and compaction temperatures, but minimally active at service temperatures. The RAS may be introduced to as-designed mixes (without RAS) up to 5% as a compaction aid, taking advantage of the active RAS binder at compaction temperature and the minimal inactivity at service temperature. Studies determined that RAS did not adversely affect the laboratory cracking and rutting performance and enhanced the compactibility of the mix. This method enhances compaction of asphalt mixtures, leading to increased pavement life and more widespread and effective use of RAS. At compaction temperature, the RAS binder fully participates in the compaction, facilitating achievement of the desired density. At the ambient service temperature, the RAS binder is largely inactive and thus does not compromise the cracking and rutting performance of an asphalt mix, nor does it demand the use of a softer binder, which may lead to a loss of polymer content in an otherwise polymer-modified asphalt binder. However, the disclosed methodology transforms the current practice of mix design and quality verification, such as the use of design air void (i.e., 4% at design gyration), void in mineral aggregate (VMA), and void filled with asphalt (VFA) as acceptance measures. Nevertheless, a direct measurement of the performance of asphalt mixture (e.g. rutting, cracking, etc), in contrast to indirect measurements (e.g., VMA, VFA, etc.), provides more confidence in the pavement performance. This disclosure includes assessments of the use of RAS as a compaction aid and its impacts on compactibility, volumetrics, rutting, and cracking performance of asphalt mixes.

A second embodiment—PlasticAid—incorporates PE of different sizes into asphalt mixtures in accordance with modified dry process as a compaction aid to facilitate compaction, rather than including plastics as part of mix design constituents. The plastic may be introduced into the as-designed control mix as an additive, to take advantage of the partial melting of PE at the production and compaction temperature and relative inactivity at service temperatures. The impact of introducing PE on compactibility, volumetric, and performance of a control mix was investigated. The results show that the asphalt mixture modified by PE improves compactibility and reduces rut depth. The use of PE flakes was observed to enhance the cracking performance of asphalt mixtures at intermediate temperatures, as evidenced by an increased CT-index. This improvement indicates that the use of PE flakes can help achieve good compaction of asphalt mixture and thus extend pavement life, as well as enabling large-quantity use of waste plastics.

Asphalt may be characterized as an organic cementitious material in which the predominant constituents are bitumens as they may occur in nature or as they may be produced as byproducts in petroleum refining operations. Asphalts can generally be characterized as a dark brown or black solid or highly viscous liquid which incorporates a mixture of paraffinic and aromatic compounds and various heterocyclic compounds containing Group 15 or 16 elements, such as nitrogen, oxygen or sulfur.

Asphalt paving materials based upon asphalt binder or “asphalt cements” and aggregate mixtures, commonly referred to as “asphalt concrete” or macadam, are used in many applications such as in the resurfacing of streets, parking lots and the like which are subject to vehicular traffic. While the asphalt may be used alone, such as where it applied as a relatively thin film on existing paving structure, it is usually used in an asphalt concrete in which the asphaltic base material is mixed with an aggregate in an amount substantially in excess of the amount of the asphalt. Typically, an asphalt concrete may contain about 5-20 wt % asphalt binder with the remainder being the aggregate material. The asphalt binder material may be modified through the use of polymers to produce polymer-modified asphalts and may further incorporate additional additives such as ground rubber, also called crumb rubber. It may also incorporate elastomeric-type polymers, such as polybutadiene, polyisoprene or polyisobutene rubber, polymethacrylate and ethylene propylene diene terpolymer.

One embodiment of the disclosure provides a method of asphalt paving, comprising obtaining a designed mix comprising loose aggregate and a virgin binder; adding recycled asphalt shingles (RAS) to the designed mix as an additive to form a RAS mix, wherein RAS is added in an amount sufficient to facilitate compaction; and compacting the RAS mix on a paving substrate at a compaction temperature.

Designed mixes are known in the art and contain loose aggregate and virgin binder. Virgin binder has not been used previously for paving and may be selected from asphalt or tar. In some embodiments, the virgin binder is added after RAS and the loose aggregate to form the RAS mix. In some embodiments, the loose aggregate and virgin binder are mixed and then the RAS is added. In some embodiments, the RAS and virgin binder are mixed and then the loose aggregate is added. In some embodiments, the RAS mix contains 1-10 wt %, e.g. 3-7 wt % virgin binder.

RAS are obtained from the manufacture or recycling of roof shingles. RAS is typically composed of 19-30% asphalt cement/binder, 40-60% hard aggregate contained on the 30 and 60 sieves and 3-12% fiber. Asphalt binder is a hydrocarbon product produced by removing the lighter fractions from crude oil during the refining process. It is generally divided into four components: saturated, aromatic, colloid, and asphaltene. RAS material can be post-consumer asphalt shingles (PCAS) and/or manufacturing waste asphalt shingles (MWAS).

In some embodiments, prior to mixing, the RAS is dried, e.g. at about 50-70° C., 55-65° C. for about 1-24 hours. The loose aggregate may be preheated to become soft enough for mixing, e.g. at about 70-110° C., e.g. 85-95° C., for 30 minutes to 2 hours or about 1 hour. In some embodiments, the heated aggregate is sufficient to dry the RAS upon mixing.

Suitable loose aggregates are uncompacted and exhibit porosity or voids. The aggregate may be comprised of aggregate particles such as stone chips, gravel, sand, and combinations thereof, and optionally recycled asphalt pavement (RAP). RAP is reprocessed pavement containing asphalt and aggregates. RAP is created when asphalt pavements are removed for various activities, including reconstruction, resurfacing, etc. Milling and full-depth removal are the two main ways to produce RAP. Typical RAP may have an asphalt content of about 2-8 wt %, e.g. 4-6 wt %.

The loose aggregate may have a nominal maximum aggregate size (NMAS) of ½ to ⅜ in. In some embodiments, the loose aggregate contains about 15-40 wt %, e.g. 20-37 wt % RAP. In some embodiments, the loose aggregate may have a 2-10%, e.g. 3-5%, e.g. about 4% air void content. The mix may optionally contain other additives suitable for use in asphalt binding materials, such as polymers, cross-linking agents, vulcanization agents, accelerators, extenders, fluxing agents, anti-stripping agents, and the like. In some embodiments, the RAS mix does not contain an anti-stripping agent and/or other additives.

In some embodiments, the RAS and the loose aggregate are mixed together, either before or after virgin binder is added, to form a RAS mix. The RAS mix may contain about 1-10 wt %, e.g. 1-5 wt %, of the RAS. The mixing step may occur at a temperature of about 100-200° C. for a period of 10 seconds to 1 hour.

Once the RAS mix is obtained, it is prepared for paving, transferred by truck to the road site or other location where the mix is applied through a suitable means onto the paving substrate, and then it is rolled/compacted to provide the final pavement. The paving substrate may be, for example, a sublayer (e.g. aggregate layer and/or binder layer) provided on a paving surface. Examples of surfaces include roads, streets, interstates, parking lots, bicycle and walk paths, airport runways, airport taxiways, and the like. The RAS additive acts to facilitate compaction such that after the compacting step, an air void content of a compacted RAS mix is decreased as compared to a compacted designed mix without RAS.

Further embodiments provide a method of asphalt paving comprising obtaining a designed mix comprising loose aggregate and a virgin binder; adding polyethylene (PE) to the designed mix as an additive to form a PE mix, wherein PE is added in an amount sufficient to facilitate compaction; and compacting the PE mix on a paving substrate.

PE is the most prevalent type of plastic waste and also the most challenging to depolymerize because of its inert carbon-carbon (C—C) bonds. PE waste or freshly manufactured PE as described herein includes, for example, both low-density polyethylene (LDPE) and high-density polyethylene (HDPE). The density of HDPE can range from 0.93 to 0.97 g/cm³, while the density of LDPE ranges from 0.91-0.94 g/cm³. HDPE has a primarily linear structure, while LDPE is branched. The PE may be one or more of powdered, shredded, or pelletized PE with a maximum dimension of about 0.5-50 mm in any dimension.

Designed mixes are known in the art and contain loose aggregate and virgin binder. The loose aggregate to be combined with the PE may have a NMAS of ½ to ⅜ in. In some embodiments, the aggregate contains about 15-40 wt %, e.g. 15-25 wt % RAP. In some embodiments, the loose aggregate may have a 2-10%, e.g. 3-5%, e.g. about 4% air void content. The mix may optionally contain other additives suitable for use in asphalt binding materials, such as polymers, cross-linking agents, vulcanization agents, accelerators, extenders, fluxing agents, anti-stripping agents, and the like. In some embodiments, the loose asphalt mix does not contain an anti-stripping agent and/or other additives.

In some embodiments, the PE, a preheated loose aggregate, and a virgin binder (e.g. asphalt or tar) are mixed together to form a PE mix. In some embodiments, the PE is mixed with the loose aggregate first, and then virgin binder is added, to produce the PE mix. In some embodiments, the loose aggregate and virgin binder are mixed first. In some embodiments, the PE and virgin binder are mixed first. The PE mix may have a binder content of about 1-10 wt %, e.g. 3-8 wt %, e.g. 5-6 wt %. The PE mix may contain about 1-10 wt %, e.g. 1-5 wt %, of the PE. The mixing step may occur at a temperature of about 100-200° C. for a period of 10 seconds to 1 hour.

Once the PE mix is obtained, it is prepared for paving, and then transferred by truck to the road site or other location where the molten mix is applied through suitable means onto the paving substrate, and then it is rolled/compacted to provide the final pavement. The paving substrate may be, for example, a sublayer (e.g. aggregate layer and/or binder layer) provided on a paving surface. Examples of surfaces include roads, streets, interstates, parking lots, bicycle and walk paths, airport runways, airport taxiways, and the like. The PE additive acts to facilitate compaction such that after the compacting step, an air void content of a compacted PE mix is decreased as compared to a compacted designed mix without PE.

The incorporation of RAS or PE into the mixes described herein provides for easier compaction, as it may lead to a significant reduction in air void. Thus, the disclosed methods may help achieve the desired level of density with a lower number of roller passes, higher density at the same level of compaction efforts, or same or higher density at lower compaction temperature. The mixtures also demonstrate excellent rutting performance without being adversely affected by the addition of RAS or PE as a compaction additive. Further, the addition of RAS or PE as described herein does not influence the overall cracking performance of the mix.

A weight percent of a component, unless specifically stated to the contrary, is based on the total weight of the formulation or composition in which the component is included. For example if a particular element or component in a composition or article is said to have 8 wt. %, it is understood that this percentage is in relation to a total compositional percentage of 100%. Further, with respect to the composition, the dry weight basis is used. That is, the wt. % is based on a total weight of dried material so that a weight of water does not significantly contribute to the total weight of material, unless stated otherwise.

As used herein, the term “about” refers to a ±10% variation from the nominal value unless otherwise indicated.

While the present invention has been illustrated by the description of embodiments thereof and specific examples, and while the embodiments have been described in considerable detail, it is not intended to restrict or in any way limit the scope of the appended claims to such detail. Additional advantages and modifications will readily appear to those skilled in the art. Thus, the invention in its broader aspects is therefore not limited to the specific details, representative apparatus and methods and illustrative examples shown and described. Accordingly, departures may be made from such details without departing from the scope or spirit of applicant's general inventive concept.

It is to be understood that this invention is not limited to particular embodiments described herein above and below, and as such may, of course, vary. It is also to be understood that the terminology used herein is for the purpose of describing particular embodiments only, and is not intended to be limiting.

Where a range of values is provided, it is understood that each intervening value between the upper and lower limit of that range (to a tenth of the unit of the lower limit) is included in the range and encompassed within the invention, unless the context or description clearly dictates otherwise. In addition, smaller ranges between any two values in the range are encompassed, unless the context or description clearly indicates otherwise.

Unless defined otherwise, all technical and scientific terms used herein have the same meaning as commonly understood by one of ordinary skill in the art to which this invention belongs. Representative illustrative methods and materials are herein described; methods and materials similar or equivalent to those described herein can also be used in the practice or testing of the present invention.

All publications and patents cited in this specification are herein incorporated by reference as if each individual publication or patent were specifically and individually indicated to be incorporated by reference, and are incorporated herein by reference to disclose and describe the methods and/or materials in connection with which the publications are cited. at which the cell reaction takes place

The citation of any publication is for its disclosure prior to the filing date and should not be construed as an admission that the present invention is not entitled to antedate such publication by virtue of prior invention. Further, the dates of publication provided may be different from the actual dates of public availability and may need to be independently confirmed.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as support for the recitation in the claims of such exclusive terminology as “solely,” “only” and the like in connection with the recitation of claim elements, or use of a “negative” limitations, such as “wherein [a particular feature or element] is absent”, or “except for [a particular feature or element]”, or “wherein [a particular feature or element] is not present (included, etc.) . . . ”.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

### EXAMPLES

### Example 1

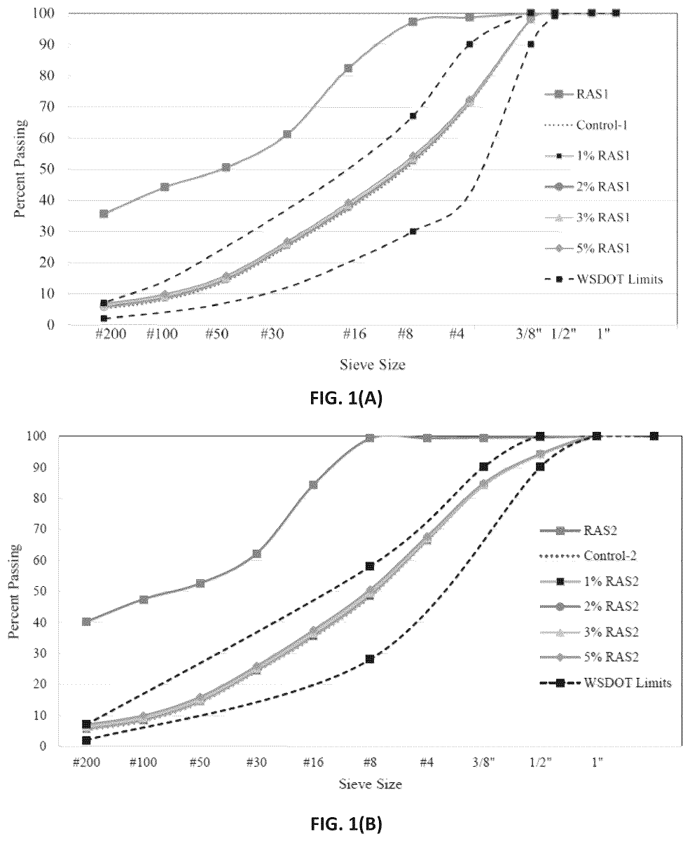

For RASAID, two as-designed loose mixes without RAS and two different RAS sources were utilized, respectively. The term ‘as-designed’ refers to non-RAS mixes that meet all volumetric and performance test requirements for construction, following Washington Department of Transportation (WSDOT) specifications. The RASAID method was studied to blend different ratios of RAS material with the control loose mixes (Control). For example, in the 5% RASAID mix, 95% of the total mass came from the Control, and the remaining 5% was added from the RAS stockpile. The first control loose mix (Control-1) was initially designed with a nominal maximum aggregate size (NMAS) of 3/8 in., 20% RAP, a total binder content of 5.8%, a virgin binder PG of 58H-22, and 0.3% anti-strip agent. This mix was then blended with a MWAS RAS stockpile selected to produce RASAID1 mixes. RAS 1 contains 16.9% asphalt content with a continuous high PG of 123.8, at different ratios. The second control loose mix (Control-2) was initially designed with an NMAS of 1/2 in., 37% RAP, a total binder content of 5.2%, a virgin binder PG of 58H-22, and without the use of an anti-strip agent. The second MWAS RAS contains 21.9% asphalt content with a PG of 128.0 and was blended with Control-2 mix to produce RASAID2 mixes. Both Control mixtures were designed to have a 4% air void content, and they were collected from the asphalt mixing plant immediately after mixing was completed. The RAS was added to the Controls in the laboratory at 1%, 2%, 3%, and 5% by weight of the total mix as compaction aids, respectively. FIG. 1 illustrates the aggregate gradation chart of RAS, control mixes, and RASAID mixes. As the majority of the RASAID mixes in this study originated from the Controls, their gradation chart did not noticeably change up to 5% RAS. From FIG. 1, it is evident that the gradation of all the RASAID mixes fell within the lower and upper limits specified by WSDOT.

Both Controls which were collected from the plant were preheated at 90° C. for one hour to become soft enough for mixing. The RAS stockpile was dried at 60° C. overnight before mixing. Then, the pan containing the Control and RAS on top of control mixes was placed in the oven at the mixing temperature of the Control mixes for 30 minutes to reach the mixing temperature of control mixes. Next, RAS was thoroughly mixed with the Control for 60 seconds to produce RASAID mixes. The RASAID mix was then placed in another oven at the compaction temperature of the Control virgin binder for 2 hours. Subsequently, the RASAID mix was compacted at the same design number of gyrations as the Control. The bulk specific gravity (Gmb) of the compacted sample was measured in accordance with AASHTO T 166 standard after the compacted RASAID mix had cooled down. The maximum specific gravity (Gmm) was measured in accordance with AASHTO T 209 standard on a loose sample of RASAID mixes, following the same procedure used to produce the compacted sample without performing the compaction at the end.

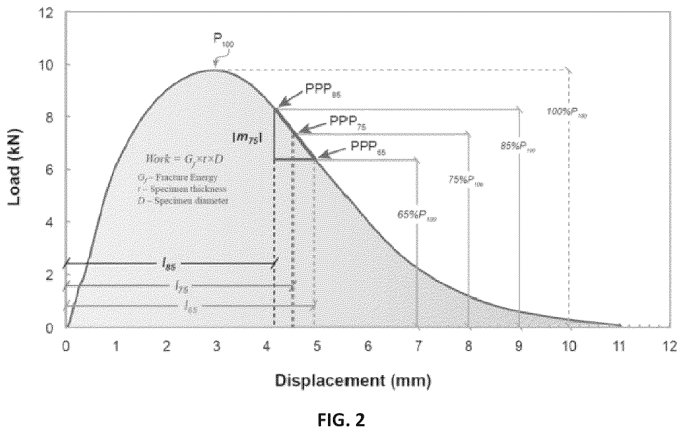

To perform the cracking and rutting tests, 62 mm thick samples with a 150 mm diameter were compacted to achieve 7%±0.5% air void content. The mixing and compaction procedure for producing performance samples was the same as the volumetric procedure explained in the previous paragraph, except for the conditioning time and temperature prior to compaction. After the mixing was completed, the pan containing the RASAID mix was conditioned for 3 and a half hours at 135° C., followed by 30 minutes at the compaction temperature of the Control's virgin binder, in accordance with WSDOT procedures. The Hamburg Wheel Tracking Test (HWTT) was performed following AASHTO T 324 standard at 50° C. to measure the rutting performance of RASAID mixes, following WSDOT protocols. The resultant rut depth after 20,000 cycles was selected as the rutting performance indicator. The IDEAL-CT test was performed following ASTM D 8225 standard to analyze the cracking performance of RASAID mixes. The parameters selected for analyzing the cracking performance were fracture energy (FE), fracture work density (FWD), IDT strength, CT-index, and flexibility index (FI). FIG. 2 demonstrates the resulting load vs. displacement curve from the IDT test. From this curve, and knowing the thickness (t) and diameter (d) of the tested specimen, the FE, FWD, IDT strength, CT-index, and FI values could be measured using Equations 1 to 5, respectively. Note that FI is based on IDT test results, instead of semi-circular bending beam (SCB) test results. Two replicates were performed for all the volumetric and performance test measurements to evaluate the consistency of the proposed methodology.

### Equations

$$FE = Area / ( t \times d ) \qquad ( 1 )$$

$$FWD = Area / Sample Volume \qquad ( 2 )$$

$$IDT Strength = ( 2 \times {P}_{100} ) / ( π \times t \times d ) \qquad ( 3 )$$

$$CT - index = ( t / 62 ) \times ( FE / \vert {m}_{75} \vert ) \times ( {l}_{75} / d ) \qquad ( 4 )$$

$$FI = FE / \vert {m}_{75} \vert \qquad ( 5 )$$

$${m}_{75} = ( {PPP}_{85} - PP {P}_{65} ) / ( {l}_{85} - {l}_{65} ) \qquad ( 6 )$$

Where:
Area=the area under the load vs. displacement curve;
Sample Volume=the volume of the tested asphalt specimen;
P₁₀₀=the peak load from the load vs. displacement curve;
t=the thickness of the tested asphalt specimen;
d=the diameter of the tested asphalt specimen;
l₇₅=the displacement at 75% of the peak load at the post-peak area;
m₇₅=the slope of the curve at 75% of the peak load at the post-peak area, calculated from Equation 6;
PPP₈₅=the 85% of the peak load at the post-peak area;
PPP₆₅=the 65% of the peak load at the post-peak area;
l₈₅=the deformation at 85% of the peak load at the post-peak area; and
l₆₅=the deformation at 65% of the peak load at the post-peak area.

### Results and Discussion

### RASAID—Volumetric Results

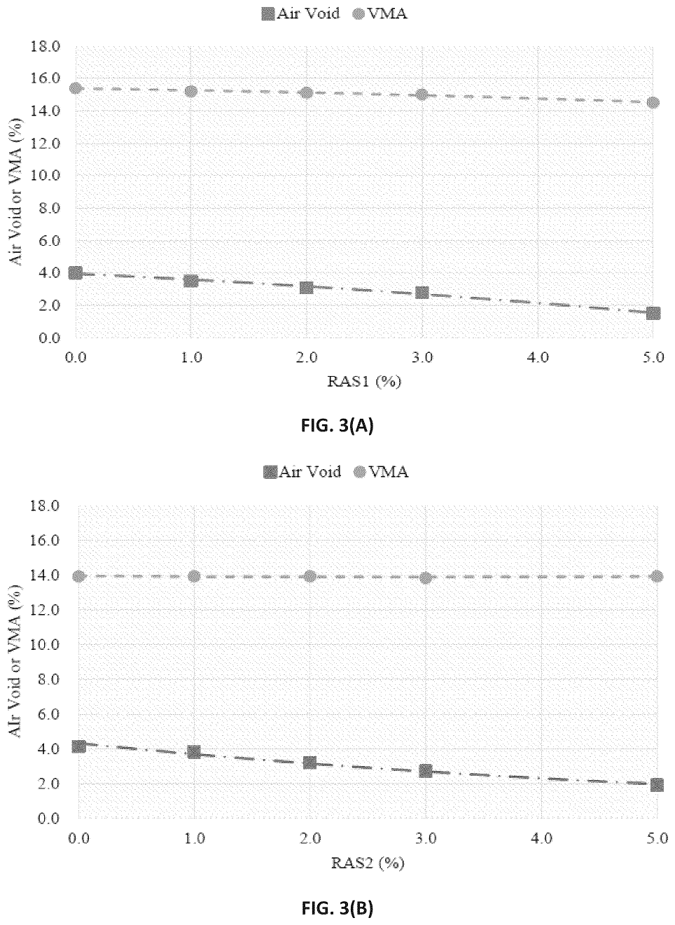

Table 1 shows the volumetric results of both Controls, as well as all the RASAID mixes, including the measured asphalt content (AC), air void content (Vₐ), VMA, and voids filled with asphalt (VFA) for different RASAID mixes. FIG. 3 also presents the changes in the air void content and VMA values with increase of the RASAID amount in the mix. As the amount of extra RAS increased in the mix, the total asphalt content also increased. This led to a decrease in the actual virgin binder in the mix, from 4.87% to 4.66% for RASAID1 mixes and from 3.39% to 3.22% for RASAID2 mixes, when the RAS content was increased from 0% to 5% for both mixes. The air void is considered in this study as an indicator to compactibility of mixes, as an exploratory study, even though other measures, such as construction densification index, can also be used. A significant decrease in the air void content was observed in RASAID mixes. This decrease in air void content would facilitate achieving higher pavement density in the field with a lower number of passes or achieving higher density at a given compaction effort. Therefore, increasing the RASAID content up to 5% could also be considered a compaction aid. The VMA of the RASAID1 mixes was reduced with the increasing amount of extra RAS in the mix. This decrease was a result of a significant decrease in air void content at higher percentages of RAS1 in the mix. For RASAID2 mixes, the air voids also decreased with the increase of RAS percentage. However, VMA remained relatively constant for all RASAID2 mixes.

TABLE 1
Statistical information for important volumetric parameters.

| Control | Amount of | | Virgin | | | |
|---|---|---|---|---|---|---|
| Mixes | RASAID | AC (%) | binder (%) | Vₐ (%) | VMA (%) | VFA (%) |
| 1 | 0% RAS1 | 5.8 | 4.87 | 4.0 | 15.4 | 74.1 |
| | 1% RAS1 | 5.9 | 4.81 | 3.5 | 15.2 | 76.9 |
| | 2% RAS1 | 6.0 | 4.75 | 3.1 | 15.1 | 79.1 |
| | 3% RAS1 | 6.1 | 4.69 | 2.8 | 15.0 | 81.4 |
| | 5% RAS1 | 6.4 | 4.66 | 1.5 | 14.5 | 89.8 |
| 2 | 0% RAS2 | 5.2 | 3.39 | 4.1 | 13.9 | 70.4 |
| | 1% RAS2 | 5.4 | 3.36 | 3.8 | 13.9 | 72.9 |
| | 2% RAS2 | 5.5 | 3.32 | 3.2 | 13.9 | 76.9 |
| | 3% RAS2 | 5.7 | 3.29 | 2.7 | 13.8 | 80.3 |
| | 5% RAS2 | 6.0 | 3.22 | 1.9 | 13.9 | 86.0 |

Note:
AC = asphalt content; Vₐ = air void; VMA = voids in mineral aggregate; and VFA = voids filled with asphalt.

### RASAID—Rutting and Cracking Results

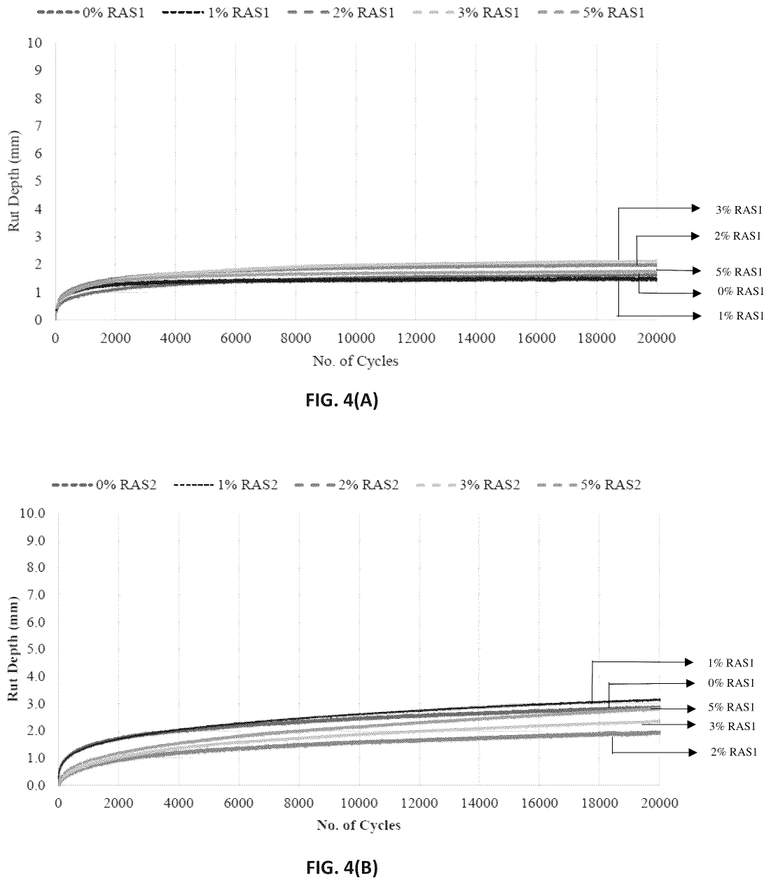

FIGS. 4(A)-(B) show the rutting results for the RASAID1 and RASAID2 mixes, respectively, after 20,000 cycles. The rut depth at the end of the 20,000 cycles for all the RASAID1mixes ranged from 1.3 mm to 2.3 mm (see FIG. 4(A)), and 1.5 mm to 3.1 mm for RASAID2 mixes (see FIG. 4(B)). All rut depths were well below the WSDOT specification of 10 mm after 15,000cycles, and none of them experienced any stripping issues. From the rutting results, it is evident that the RASAID ratio can go above 5%, as it did not show any rutting or stripping issues even after 20,000 loading cycles. It should also be noted that the Control-1 mix used in this study was already designed with 0.3% anti-stripping agent, an additive that can enhance the rutting performance of the mix. However, the rut depth of RASAID2 mixes (which was designed without a stripping agent) did not experience a significant change either (see FIG. 4(B)).

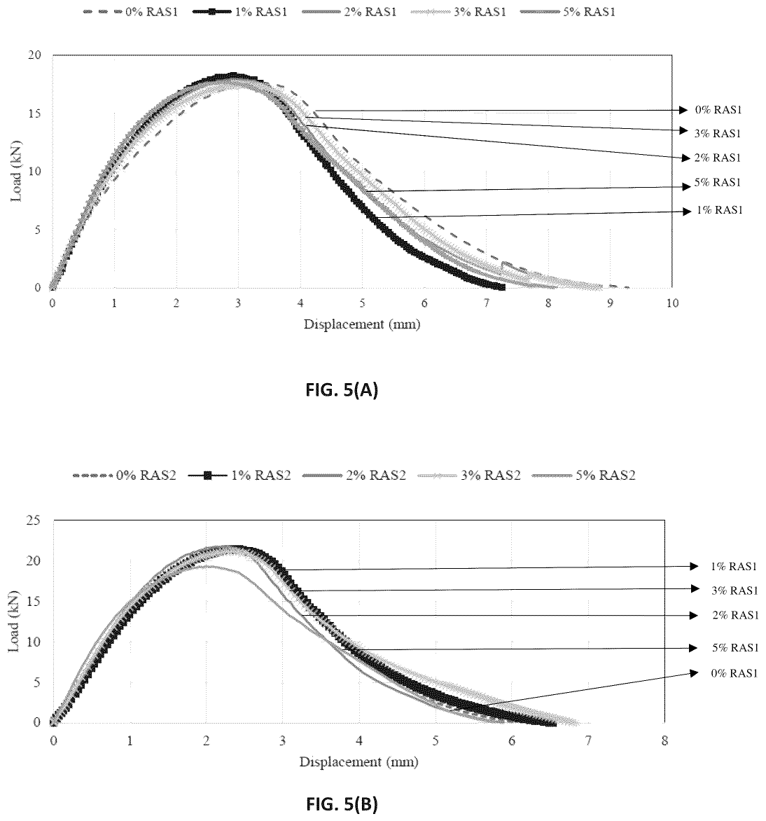

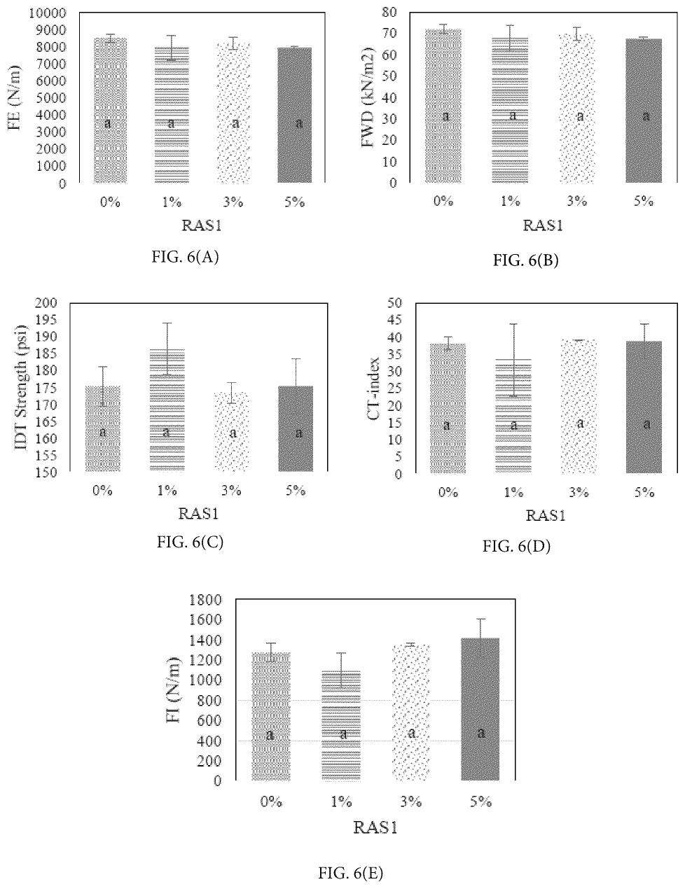

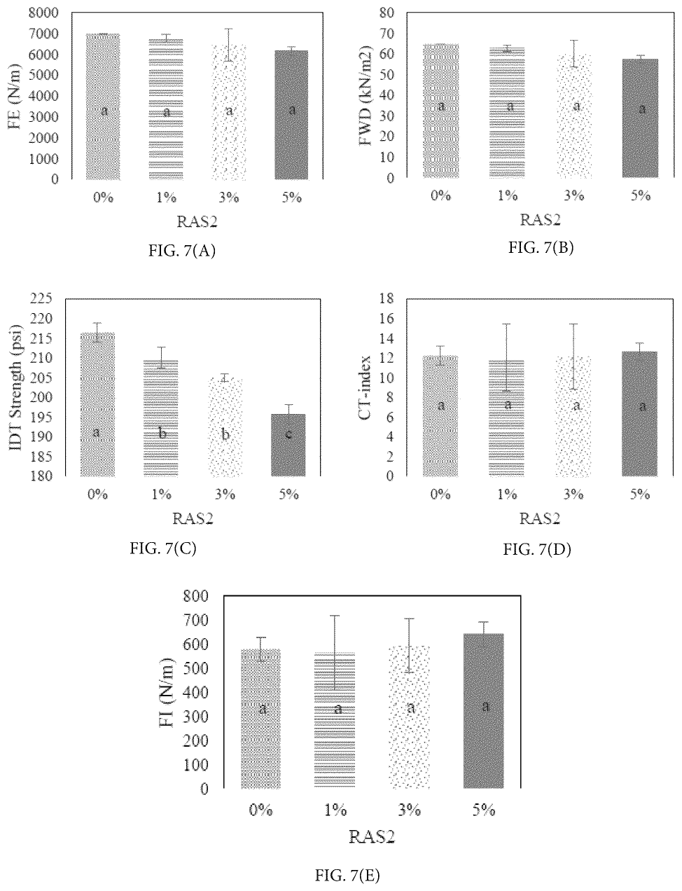

FIG. 5 presents the results of the performed indirect tension test on the Control and RASAID mixtures. Similar to the rutting test, the cracking test results of these mixtures were close to each other, regardless of the RAS amount. Various cracking indices were calculated from the preformed indirect tension test, and the results are presented in Table 2. The trends of these calculated indices are also shown in FIGS. 6 & 7 for RASAID1 and RASAID2 mixtures, respectively. To identify any statistically significant changes between any two bands for the same index, the Tukey post-hoc test was applied. The p-value of 0.05 was chosen as the threshold; a p-value lower than 0.05 between two bands indicates a statistically significant difference between them. The Tukey post-hoc test results are depicted with connecting alphabets on the bars. Any two bars with no letters in common have a statistically significant difference based on the Tukey post-hoc analysis.

TABLE 2
Different cracking indices results for RAS 1 and RAS2 mixes.

| Control | Cracking | | | | | |
|---|---|---|---|---|---|---|
| Mixes | Index | 0% RAS | 1% RAS | 2% RAS | 3% RAS | 5% RAS |
| 1 | FE (N/m) | 8497.41 | 7960.44 | 8020.66 | 8211.97 | 7931.47 |
| | FWD | 72.13 | 67.57 | 68.08 | 69.71 | 67.32 |
| | (kN/m²) | | | | | |
| | IDT Strength | 175.29 | 186.44 | 177.62 | 173.44 | 175.25 |
| | (psi) | | | | | |
| | CT-index | 38.18 | 33.32 | 33.41 | 39.18 | 38.76 |
| | FI (N/m) | 1272.98 | 1098.08 | 1210.48 | 1351.25 | 1416.19 |
| 2 | FE (N/m) | 6989.84 | 6773.41 | 6362.90 | 6466.86 | 6174.21 |
| | FWD | 65.01 | 62.99 | 59.17 | 60.14 | 57.42 |
| | (kN/m²) | | | | | |
| | IDT Strength | 216.42 | 210.13 | 209.55 | 205.07 | 195.74 |
| | (psi) | | | | | |
| | CT-index | 12.22 | 12.08 | 10.35 | 12.15 | 12.64 |
| | FI (N/m) | 577.24 | 564.93 | 515.79 | 593.51 | 639.74 |

For RASAID1 mixtures, no statistically significant difference in the cracking parameters was observed with the addition of RAS up to 5%. Similarly, for RASAID2 mixtures, as the RAS content increased, the Tukey post-hoc tests show no statistically significant difference, with p-values higher than 0.05 for all the cracking indices, except the IDT strength. A p-value of 0.03 was obtained when the RAS was added by 1% and 3%, and 0.001 when it was added by 5%, compared to the IDT strength of the control mix. This indicates a statistically significant decrease in IDT strength for RASAID2 mixtures. It is worth noting that all the mixtures had an IDT strength lower than the current maximum of 150 psi IDT strength, as specified by WSDOT. The use of RAS as an aid helps meet WSDOT specifications in terms of maximum IDT strength.

In summary, incorporating RAS up to 5% using the RASAID approach maintains rutting and cracking performance while improving compactibility. The improved compaction can enhance durability, mitigate challenges associated with designing high RAP/RAS mixes, and increase the widespread and effective use of RAS.

### Conclusions

Currently, RAS is used as a constituent of mix design. However, measures must be taken to mitigate the cracking susceptibility associated with its use, which has resulted in a decreased popularity of designing high RAS mixes in recent years. In response to this challenge, this study provides a new method, referred to as RASAID, that treats RAS as a mix additive in already designed mixes. The methodology involves adding different ratios of MWAS RAS (up to 5%) to controlled loose mixes designed without RAS (Control-1 and Control-2), and evaluating their effects on the volumetric and performance properties of the Controls.

The following findings, drawn from the outcomes of this study, are offered here:
1. Increasing the RAS from 0% to 5% led to a 0.2% and 0.17% decrease in the virgin binder content in the RASAID mixes, while the total binder content increased by 0.6% and 0.8% in RASAID1 and RASAID2 mixtures, respectively.
2. Based on the volumetric results, increasing the RASAID content resulted in easier compaction, as the air void decreased from 4% for the Control-1 mix with no RAS, to 1.5% for the 5% RASAID mix. Similarly, in the case of Control-2 mixtures, introducing RASAID content up to 5% also led to a significant reduction in air void, from 4.1% to 1.9%. This finding suggests that implementing this method in the field could help contractors achieve the desired level of density with a lower number of roller passes or higher density at the same level of compaction efforts.
3. The RASAID mixtures demonstrated excellent rutting performance without being adversely affected by the addition of RAS as a compaction additive.
4. The addition of RAS up to 5% as a compaction aid does not influence the overall cracking performance of the mix.

### Example 2

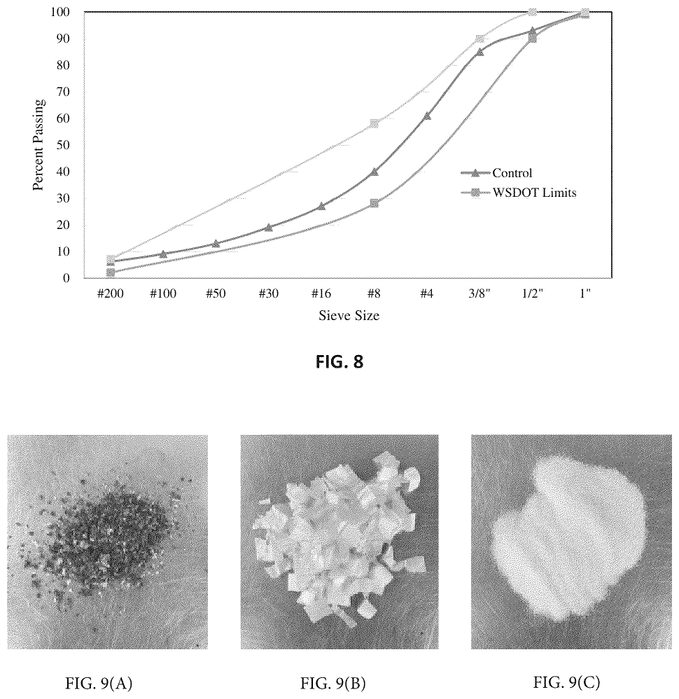

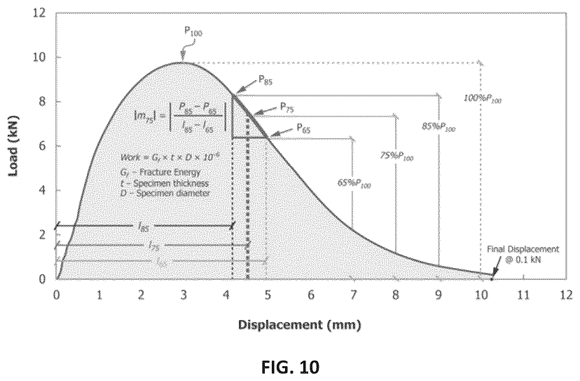

For PlasticAid, one control asphalt mixture (referred to as “Control”) and waste PE with three different sizes or forms were used and compared. The Control mix has a nominal maximum aggregate size (NMAS) of 12.5 mm (½ in.), 5.1% asphalt binder content (Pb) with the performance grade (PG) of 58H-22, and 20% of recycled asphalt pavement (RAP). FIG. 8 shows the gradation of the Control mix and the specified lower and upper limits provided by the Washington Department of Transportation (WSDOT). Three different post-consumer plastics were used for evaluation: (1) a mix of shredded LDPE and high-density polyethylene (HDPE) (PEM) with a size ranging from 1 mm to 5 mm (see FIG. 9(A)); (2) LDPE flake (PEF) cut from plastic bags measuring approximately 10 mmx10 mm (see FIG. 9(B)); and (3) HDPE powder (PEP) with a size of 0.6 mm (see FIG. 9(C)). The waste PE was added as an additive to the Control mix at different ratios. For instance, a 5% PlasticAid mix contains 5% waste plastic and 95% Control mix. This methodology was then followed by the modified dry process.

To prepare PlasticAid mixtures for determining the volumetric properties, the control mix was heated at the mixing temperature (based on asphalt binder) for 30 minutes to allow the mixture to be sufficiently loose for mixing. Then, the waste PE was added and mixed with the Control mix for 120 seconds to ensure thorough distribution within the mixture. The PlasticAid mixture was then placed at the compaction temperature (based on that of asphalt binder) for 2 hours, with periodic stirring at one-hour intervals. It was observed that the waste PE would begin to soften and melt during the conditioning process. The mix was compacted to the same gyration number as the control mix upon the completion of the conditioning. The compacted specimens were later tested for bulk specific gravity (Gmb) following AASHTO T 166. The maximum specific gravity (Gmm) was determined from a conditioned loose mixture, in accordance with AASHTO T 209. The sample conditioning procedure for performance testing followed a similar procedure to that of the volumetric samples, except for the compaction oven conditioning time and temperature. For performance samples, the plastic-modified loose mixtures were subjected to a conditioning temperature of 135° C. for 3.5 hours, followed by 0.5 hour at the compaction temperature, prior to compacting to dimensions of 150 mm diameter and 62 mm height, with the Vₐ content maintained at 7% +0.5%, in accordance with WSDOT protocol.

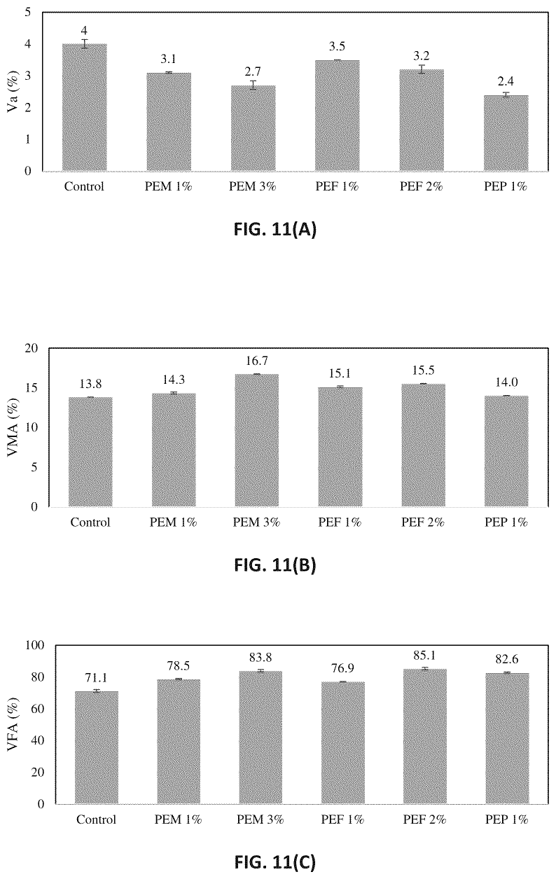

The rutting performance was evaluated using the Hamburg Wheel Tracking Test (HWTT) following AASHTO T 324. The mixtures were submerged in water at 50±2° C. The rut depth after 20,000 cycles was selected as the rutting performance indicator. For the cracking performance test, a servo-hydraulic device was employed to apply a displacement rate of 2 inches per minute, in accordance with ASTM D 8225. The IDT strength, CT-index, and IDT flexibility index (FI) were calculated using Equations 7, 8, and 9, respectively. The CT-index used in this study determines the cracking performance of the asphalt mixture at intermediate temperatures, based on the load-displacement curve obtained from IDT test (see FIG. 10). The IDT FI equation was specifically designed for the semi-circular beam test. However, the FI parameter in this study was determined by analyzing the results obtained from the IDT. To increase the accuracy of the cracking test results, indexes were determined based on the average of three replicates.

### Equations

$$IDT Strength = ( 2 \times {P}_{100} ) / ( π \times t \times d ) \qquad ( 7 )$$

$$CT - index = ( t / 62 ) \times ( {G}_{f} / {m}_{75} ) \times ( {l}_{75} / d ) \qquad ( 8 )$$

$$FI = {G}_{f} / {m}_{75} \qquad ( 9 )$$

$${G}_{f} = Area / ( txd ) \qquad ( 10 )$$

Where:
P₁₀₀ is the peak load;
l₇₅ is the displacement at 75% of the post-peak load;
m₇₅ is the absolute value of the slope of the curve at 75% of the post-peak load;
Area is the area under the load vs. displacement curve.

### Results and Discussion

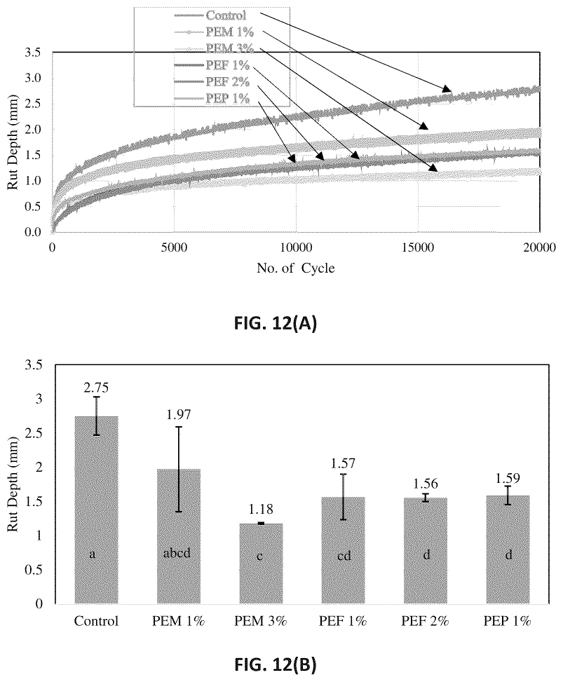

Table 3 shows the volumetric properties of Control and plastic-modified mixes. As the waste PE content increased in the asphalt mixture, the total Pb content decreased, because the total mass of the mix increased. This suggests that incorporating waste PE in asphalt mixtures can slightly reduce the use of raw materials and construction costs while also mitigating the environmental impact of plastic waste in landfills. Waste PE effectively fills the voids, consequently leading to a reduction in the Vₐ content (see FIG. 11(A)). Among the different waste PE types, PEP led to the highest reduction in Vₐ. The reduced size of PEP particles enables them to efficiently fill the voids in the asphalt mixture, leading to an increase in the overall density. As the percentage of PEM and PEF increases in PlasticAid mixtures, the Vₐ content decreases. As a result of the Vₐ reduction, waste PEs can reduce the compaction efforts needed to achieve the desired density during road paving or achieve high compaction density with a given compaction effort. The presence of waste PE has also led to an increase in VMA in the mixture. In FIG. 11(B), PEF-modified mix resulted in the highest VMA compared to other modified mixes with the same dosage of added plastic. Plastic-modified mixes also resulted in an increase in the mix VFA (see FIG. 11(C)). The inclusion of PE, particularly in PEP-modified mixtures, has the most significant impact on increasing VFA compared to PEM and PEF.

TABLE 3
Volumetric properties of Control with
different plastic sizes and content.

| Sample ID | P_{b} | Vₐ | VMA | VFA |
|---|---|---|---|---|
| Control | 5.1 | 4.0 | 13.8 | 71.1 |
| PEM 1% | 5.0 | 3.1 | 14.3 | 78.5 |
| PEM 3% | 4.9 | 2.7 | 16.7 | 83.8 |
| PEF 1% | 5.0 | 3.5 | 15.1 | 76.9 |
| PEF 2% | 5.0 | 3.2 | 15.5 | 85.1 |
| PEP 1% | 5.0 | 2.4 | 14.0 | 82.6 |

### PlasticAid—Rutting Test Results

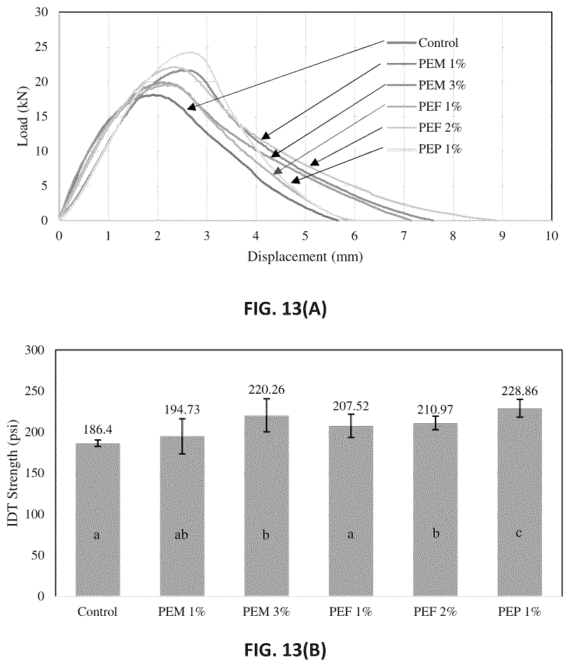

FIG. 12(A) shows the rutting performance of asphalt mixtures subjected to wheel loads for 20,000 cycles. From this figure, the rutting resistance has been improved with the addition of waste PE in various amounts, compared to the Control mix. This decrease can be explained as the overall stiffness and affinity of the asphalt mixture was enhanced by the incorporation of plastic. Moreover, no stripping was observed in any of the mixtures. FIG. 12(B) shows the final rut depth after 20,000 cycles of the tested mixtures. To statistically assess the impact of incorporating waste PE on the rutting performance, a t-test was employed with a p-value threshold of 0.05. A p-value lower than 0.05 indicates a statistically significant difference. The t-test result is shown on the bars with letters; two bars with no letters in common have statistically significant difference. The overall rut depth of all the tested specimens was observed to be between 1.18 mm to 2.75 mm. In general, the t-test result shows that there is a significant decrease in rut depth with the inclusion of waste PE. Asphalt mixture with 3% of PEM showed the most significant impact on improving the rutting resistance, with a p-value of 0.0006 compared to Control.

### PlasticAid—Cracking Test Results

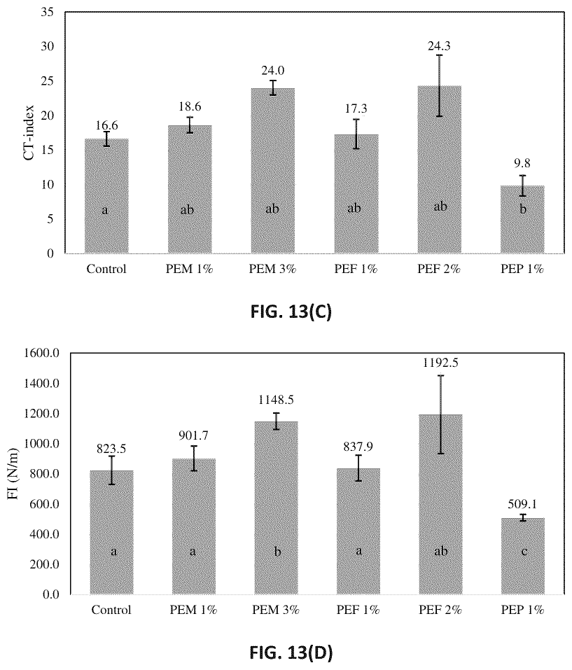

FIG. 13 represents the cracking performance of the Control and PlasticAid mixtures. The load-displacement curve (see FIG. 13(A)) shows that PlasticAid mixes have higher fracture energy as they have lager area under the load-displacement curve compared to the control mix. This increased fracture energy is an indicator of improved cracking performance, especially during the post-peak area (crack propagation stage). The impact of waste PE on the cracking parameters, namely IDT strength, CT-index, and FI, are presented in bar charts in FIGS. 13(B)-(D), respectively. The Tukey post-hoc test results show that the IDT strength increased with the increased amount of incorporated waste PE into the asphalt mixture (see FIG. 13(B)). In this case, the cause of increases in the IDT strength of the asphalt mixture is mainly dominated by the type of waste PE. The PEP contributed the highest IDT strength to the asphalt mixture, which was significantly different from the Control, as detected by the Tukey post-hoc test (p-value of 0.039). This can be contributed by the high stiffness of HDPE. In contrast, the results of CT-index are highly dependent on the type and size of the waste PE. FIG. 13(C) shows that CT-index increased along with the increased percentage of PEM and PEF in the asphalt mixture. The cracking resistance improved when the PEM and PEF were increased by more than 1%. The asphalt mixtures modified with 2% PEF (p-value of 0.012) and 3% PEM (p-value of 0.016) showed a significantly higher CT-index compared to the Control mix. A similar trend was also observed in the FI cracking index. According to FIG. 13(D), the plastic-modified mix with 3% PEM (p-value of 0.006) shows a significant improvement compared to the Control mix. It has been observed that with the modified dry process, PEM and PEF remain in large-sized form. In addition to the adhesion, PEM and PEF provide reinforcement and interlocking enhancement between binder-coated aggregates. Moreover, PE reduces the stress concentration in the asphalt mixture, thereby delaying crack initiation. However, the incorporation of PEP significantly reduced the cracking resistance of the asphalt mixture, showing a p-value of 0.027 in the CT-index parameter (see FIG. 13(C)) and a p-value of 0.0047 in the FI parameter (see FIG. 13(D)). This can be explained by the fact that HDPE in powder form primarily increases stiffness. However, PEP does not offer substantial reinforcement, leading to inadequate stress concentration handling upon the application of load to the asphalt mixture.

### Conclusions

Utilizing waste plastic to modify asphalt mixtures is considered a cost-effective approach that has the potential to reduce raw material consumption and addresses environmental concerns. However, there is still a lack of comprehensive understanding regarding the influence of applying waste plastic with different types and sizes/forms on the asphalt mixtures. This study evaluated the volumetric properties and performance of asphalt mixtures modified with different sizes of waste PE as additive using a modified dry process. The following conclusions can be drawn from the findings of this study:
1. By incorporating waste PE as an additive in the Control mix, a reduction in the Pb content was observed. Specifically, when 3% of PEM was added to the Control, the Pb content experienced a significant decrease of 3.92%. This indicates that incorporating waste PE effectively reduces the use of asphalt binder and serves as a cost-effective approach.
2. Despite the reduction in Pb content in the Control mix, the Vₐ content of the mixture was also decreased. This reduction in Vₐ content resulted in a decrease in the number of wheel passes required to achieve the desired density during road paving.
3. The Controls modified by waste PE exhibited higher VMA and VFA compared to Control mix. PEF demonstrated a superior capability in increasing VMA, while PEP has the highest influence on increasing VFA.
4. As the PE content increased, the overall rut depth of the mixtures modified by PE additive in each number of cycles were lower than that of the Control. The Tukey post hoc test determined the most significant reduction in rut depth after 20,000 cycles of loads, with the Control containing 3% of PEM.
5. The Tukey post hoc test results indicate that the cracking performance of the asphalt mixture is predominantly dependent on the size of waste PE. According to the obtained p-value, with a larger waste PE size, the CT-index and FI were improved significantly by the provided binding reinforcement and filler effect. However, PEP negatively affects the cracking performance of the asphalt mixture.

The findings of this study highlight the positive impact of utilizing waste PE to modify Control mix, enhancing both its volumetric properties and performance. Specifically, the increase in IDT strength, CT-index, FI showed that asphalt mixtures modified with large-sized waste PE flakes demonstrated remarkable effectiveness in preventing cracking.

### Caveats

Although the description here contains many details, these should not be construed as limiting the scope of the disclosure but as merely providing illustrations of some of the presently preferred embodiments. Therefore the scope of the disclosure encompasses other embodiments which may become obvious to those skilled in the art.

In these claims, reference to an element in the singular is not intended to mean “one and only one” unless explicitly stated, but rather “one or more.” All structural, chemical, and functional equivalents to the elements of the disclosed embodiments that are known to those of ordinary skill in the art are expressly incorporated herein by reference and are intended to be encompassed by the present claims. Furthermore, no element, component, or method step in the present disclosure is intended to be dedicated to the public regardless of whether the element, component, or method step is explicitly recited in the claims. No claim element is to be construed as a “means plus function” element unless the element is expressly recited using the phrase “means for . . . .” No claim element is to be construed as a “step plus function” element unless the element is expressly recited using the phrase “step for . . . .”It should be emphasized that the above-described embodiments and specific examples of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

What is claimed:

1. A method of asphalt paving, comprising:
obtaining a designed mix comprising loose aggregate, a virgin binder, and optionally recycled asphalt pavement (RAP);
adding recycled asphalt shingles (RAS) to the designed mix as an additive to form a RAS mix, wherein RAS is added in an amount sufficient to facilitate compaction; and
compacting the RAS mix on a paving substrate at a compaction temperature.

2. The method of claim 1, wherein the virgin binder is selected from asphalt or tar.

3. The method of claim 1, wherein after the compacting step, an air void content of a compacted RAS mix is decreased as compared to a compacted designed mix without RAS.

4. The method of claim 1, wherein the RAS mix contains 3-7 wt % virgin binder.

5. The method of claim 1, wherein the RAS mix comprises RAP.

6. The method of claim 1, wherein the RAS mix contains 0.1-10 wt % of the RAS.

7. The method of claim 1, wherein the adding step comprises mixing at a temperature of 100-200° C. for 5 seconds to 1 hour.

8. The method of claim 1, wherein the compaction temperature is 100-200° C.

9. A method of asphalt paving, comprising:
obtaining a designed mix comprising loose aggregate and a virgin binder;
adding polyethylene (PE) to the designed mix as an additive to form a PE mix, wherein PE is added in an amount sufficient to facilitate compaction; and
compacting the PE mix on a paving substrate.

10. The method of claim 9, wherein the PE is one or more of powdered, shredded, and pelletized PE with maximum dimension of 0.1-50 mm.

11. The method of claim 9, wherein the virgin binder is selected from asphalt or tar.

12. The method of claim 9, wherein after the compacting step, an air void content of a compacted PE mix is decreased as compared to a compacted designed mix without PE.

13. The method of claim 9, wherein the PE mix contains 3-7 wt % virgin binder.

14. The method of claim 9, wherein the PE mix comprises further comprises recycled asphalt pavement (RAP).

15. The method of claim 9, wherein the PE mix contains 0.1-10 wt % of the PE.

16. The method of claim 9, wherein the adding step comprises mixing at a temperature of 100-200° C. for 5 seconds to 1 hour.

17. The method of claim 9, wherein the compaction temperature is 100-200° C.
